(19) United States
(12) Patent Application Publication
(10) Pub. No.: US 2026/0336291 A1
(43) Pub. Date: Oct. 29, 2026

(54) LIQUID EJECTION HEAD AND MANUFACTURING METHOD OF LIQUID EJECTION HEAD

(71) Applicant: CANON KABUSHIKI KAISHA, Tokyo (JP)

(72) Inventor: TAKASHI TERAGAKI, Kanagawa (JP)

(21) Appl. No.: 19/650,530

(22) Filed: Apr. 17, 2026

(30) Foreign Application Priority Data
Apr. 25, 2025 (JP) 2025-073568
Feb. 19, 2026 (JP) 2026-025552

(51) Int. Cl. B41J 2/14; B41J 2/16

(52) U.S. Cl. CPC B41J 2/14201; B41J 2/1607; B41J 2/1623; B41J 2002/14491

(57) ABSTRACT

A liquid ejection head includes: an element substrate including an energy element, circuit wiring that transmits a signal to the energy element, a protection film including a region covering the circuit wiring and an opening exposing the circuit wiring, and an electrode electrically connected with the circuit wiring via the opening of the protection film; and a substrate including wiring electrically connected to the electrode, in which the element substrate and the substrate are bonded by a resin material, while the element substrate and the substrate are electrically connected to each other with the electrode and the wiring overlapping each other in a facing state, and the opening of the protection film that is in a position overlapping the electrode is in a position not overlapping a contact region between the electrode and the wiring while viewing from a direction perpendicular to the element substrate.

### BACKGROUND

### FIELD OF THE TECHNOLOGY

The present disclosure relates to a liquid ejection head and a manufacturing method of the liquid ejection head.

### DESCRIPTION OF THE RELATED ART

It has been known that an ink jet printer includes a liquid ejection head that ejects a liquid from an ejection port by applying energy to the liquid. The liquid ejection head includes an element substrate on which an ejection energy generation element, circuit wiring used to drive the ejection energy generation element, an electrode terminal electrically connected to the circuit wiring, and the like are formed. The electrode terminal on the element substrate is covered with a protection film that protects the circuit wiring from water, ink, and so on. In some cases, the protection film is damaged in a case where pressure-bonding is performed on the electrode terminal and the wiring.

Japanese Patent Laid-Open No. 2022-092357 (PTL 1) discloses an electric connection method in which a resin film having elasticity extends outward and a plating bump is formed. In PTL 1, it is possible to suppress the damage of the protection film in a case of the pressure-bonding by using the method.

In the liquid ejection head of PTL 1, the size of the electrode terminal is small in a case where an interval between the electrode terminals is a narrow pitch. Therefore, it is difficult to increase the thickness by laminating plating and the like. In a case where the thickness of a multilayer body including a plating layer is increased, the contact achieved by the pressure-bonding is varied. Additionally, in a configuration with the narrow pitch, in general, thermosetting resin such as non-conductive resin is used, and in a case of the pressure-bonding via a resin material, the protection film in the vicinity of a through-hole may be damaged due to the concentration of stress in the vicinity of the through-hole below the electrode terminal.

### SUMMARY

Therefore, the present disclosure is directed to suppressing damage of a protection film in the vicinity of a through-hole below the electrode terminal due to an effect of a load caused by a pressure-bonding tool in a configuration which an electrode terminal on an element substrate and wiring on a substrate extending from an external circuit are electrically connected to each other by using a thermosetting resin material such as non-conductive resin.

A liquid ejection head includes: an element substrate including an energy element that ejects a liquid from an ejection port, circuit wiring that transmits a signal to the energy element, a protection film including a region covering the circuit wiring and an opening exposing the circuit wiring, and an electrode electrically connected with the circuit wiring via the opening of the protection film; and a substrate including wiring electrically connected to the electrode, in which the element substrate and the substrate are bonded by a resin material, while the element substrate and the substrate are electrically connected to each other with the electrode and the wiring overlapping each other in a facing state, and the opening of the protection film that is in a position overlapping the electrode is in a position not overlapping a contact region between the electrode and the wiring while viewing from a direction perpendicular to the element substrate.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of a liquid ejection unit;

FIG. 2 is a schematic view illustrating damage of a protection film on an element substrate and is a diagram for describing in the present disclosure a problem of an element substrate;

FIG. 3A is a plan view of an element substrate, and FIG. 3B is an enlarged view of a IIIB portion in FIG. 3A;

FIG. 4 is a cross-sectional view of the element substrate of the present disclosure;

FIG. 5 is a plan view of an electrode terminal on the element substrate of the present disclosure;

FIG. 6A is a plan view of a substrate (flexible substrate), and FIG. 6B is an enlarged view of a VIB portion in FIG. 6A;

FIG. 7 is a cross-sectional view of wiring on the substrate (flexible substrate);

FIG. 8 is a plan view of the wiring on the substrate (flexible substrate);

FIG. 9 is a flowchart illustrating a method of electric connection in an embodiment of the present disclosure;

FIG. 10 is a plan view illustrating a tool and a pressurization region;

FIG. 11 is a schematic view illustrating a state in which NCP is applied to the electrode terminal on a chip;

FIG. 12 is a schematic view illustrating a state before pasting the chip (element substrate) and the flexible substrate together;

FIG. 13 is a schematic view of a chip unit illustrating a state after pasting the chip (element substrate) and the flexible substrate together;

FIG. 14 is a cross-sectional view illustrating a state before pasting the chip (element substrate) and the flexible substrate together;

FIG. 15 is a cross-sectional view illustrating a state after pasting the chip (element substrate) and the flexible substrate together;

FIG. 16 is a schematic view illustrating the tool and the pressurization region;

FIG. 17 is a cross-sectional view in a case where a region including a through-hole is pressurized by the tool;

FIG. 18 is a cross-sectional view in a case where a region including no through-hole is pressurized by the tool;

FIGS. 19A and 19B are cross-sectional views of the outside of the pressurization region, FIG. 19A is a cross-sectional view of the region including the through-hole, and FIG. 19B is a cross-sectional view of the region including no through-hole;

FIG. 20 is a plan view of another embodiment of the tool and the pressurization region;

FIG. 21 is a plan view of yet another embodiment of the tool and the pressurization region;

FIG. 22 is a schematic view of pasting the electrode terminal of the chip and the wiring of the flexible substrate together;

FIG. 23 is another schematic view of pasting the electrode terminal of the chip and the wiring of the flexible substrate together;

FIG. 24 is a plan view of an abutting region between the tool and the wiring;

FIG. 25 is a plan view of another mode of the abutting region between the tool and the wiring;

FIG. 26 is a cross-sectional view of the abutting region between the tool and the wiring; and

FIG. 27 is a cross-sectional view in a case where sealing resin is provided after the chip (element substrate) and the flexible substrate are pasted together.

### DESCRIPTION OF THE EMBODIMENTS

Hereinafter, embodiments of the present disclosure are described with reference to the drawings. Note that, the following descriptions are not intended to limit the scope of claims beyond necessity.

In the descriptions in the present specification, directions may be defined by an X axis, a Y axis, and a Z axis. The axes are each indicated by a direction axis with an arrow that is illustrated in each drawing.

In the present specification, in a case of specifying the direction of each axis, a direction in which the arrow is directed in the axis of the X, Y, or Z direction is defined as a "+" direction of each axis. That is, as for a direction of "+" or "-" of each axis, the "+" direction is a direction in which the arrow is directed, and the "-" direction is a direction opposite to the direction in which the arrow is directed. Additionally, in a case of mentioning the direction of the axis without specifying the direction of "+" or "-," it is simply referred to as an "X axis direction," a "Y axis direction," or a "Z axis direction".

In the following descriptions, a configuration using non-conductive paste (NCP) in which a resin material is non-conductive resin is applied; however, the configuration is merely an example. As a material that allows the electric connection by using the non-conductive resin, there is the NCP or a non-conductive film (NCF). Additionally, as a similar material, there is also anisotropic conductive paste (ACP) or an anisotropic conductive film (ACF) that allows the electric connection by using anisotropic conductive materials. As the materials thereof, a thermosetting resin material is used as a resin adherence material. The conductive paste and the conductive film are cured with heat and can maintain a state of the electric connection by contraction force in a case of curing.

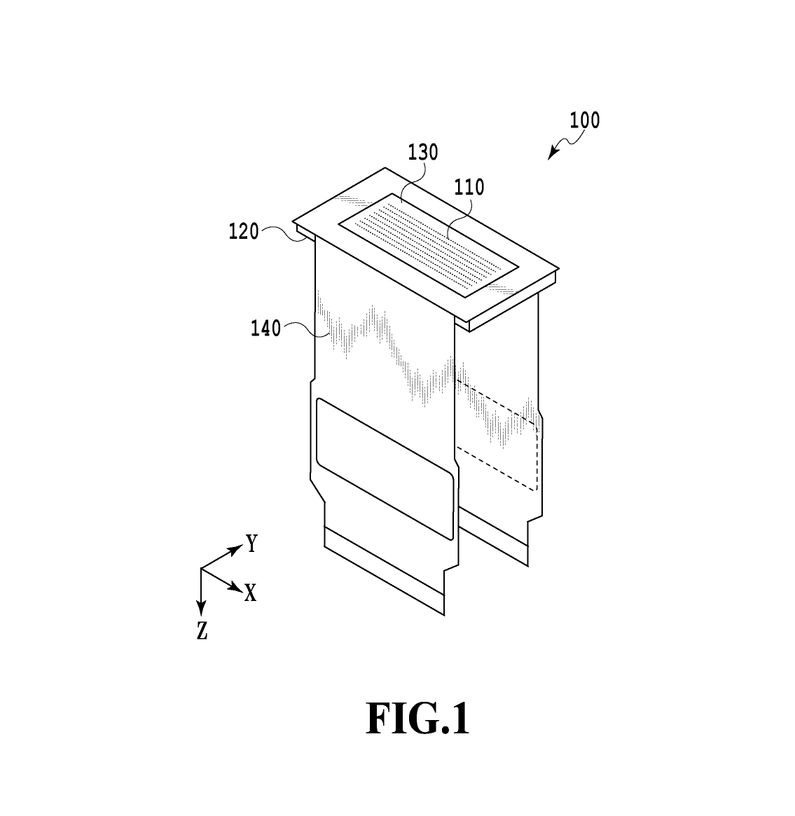

The present disclosure relates to a liquid ejection head for a liquid ejection apparatus and a manufacturing method thereof. The liquid ejection apparatus is configured to perform printing by ejecting a liquid such as an ink onto a printing medium such as paper and a plastic sheet. The liquid ejection apparatus includes a liquid ejection head, and the liquid ejection head includes a liquid ejection unit. The liquid ejection unit forming the liquid ejection head is illustrated in FIG. 1.

As illustrated in FIG. 1, a liquid ejection unit 100 includes an element substrate (in the present specification, also referred to as a chip) 130. The element substrate 130 includes an ejection port array 110 from which the liquid is ejected, a flow channel member 120 communicating with an ejection port, an element (an energy generation element, an ejection element, or the like) that generates energy to eject the liquid from the ejection port, and the like. The liquid ejection unit 100 further includes a substrate 140 extending from the outside. Specifically, the element substrate 130 includes the energy element configured to eject the liquid from the ejection port, circuit wiring configured to transmit a signal to the energy element, a protection film including a region covering the circuit wiring and an opening exposing the circuit wiring, and an electrode terminal (electrode) electrically connected with the circuit wiring via the opening of the protection film. As an example of the substrate (in the present specification, also referred to as simply the "substrate" or a "flexible substrate") 140 extending from the outside, there are a flexible substrate or a flexible printed substrate (Flexible Printed Circuit (FPC)), tape automated bonding (TAB), and the like. The element substrate 130 includes an electrode terminal 200, and the substrate (flexible substrate) 140 includes wiring 210 connected to the electrode terminal 200.

As above, in the liquid ejection unit 100, the electrode terminal 200 of the element substrate 130 and the wiring 210 of the substrate (flexible substrate) 140, which are described above, are electrically connected to each other to drive the energy generation element configured to eject the liquid, and thus it is possible to eject the liquid.

### Description of Details Leading to Present Disclosure

Hereinafter, details leading to the present disclosure are described.

The liquid ejection head includes the element substrate on which a printing element, the circuit wiring used to drive the printing element, the electrode terminal electrically connected to the circuit wiring, and the like are formed. The circuit wiring on the element substrate is covered with the protection film that protects the circuit wiring from water, ink, and so on. The protection film includes a region covering the circuit wiring and an opening exposing the circuit wiring. The electric connection can be performed by overlapping. In the present disclosure, as a specific means for a case of performing the electric connection by overlapping, for example, there may be a method in which pressure-bonding is performed on one wiring by applying a pressure by using heat or ultrasonic waves by a tool that can perform pressurization (in the present specification, also referred to as a pressurization component or a pressure-bonding tool). In the present disclosure, it is desirable to perform the electric connection by overlapping the electrode terminal (electrode) and the wiring to be put in contact with each other, and the pressure-bonding is performed on a region in which the electrode terminal (electrode) and the wiring are put in contact with each other (contact region). Accordingly, description related to the connection between the electrode terminal (electrode) and the wiring in the present disclosure is provided with a case where the pressure-bonding is performed on the electrode terminal (electrode) and the wiring by the above-described pressure-bonding tool as an example. Note that, the means for the electric connection by putting the electrode terminal (electrode) and the wiring in contact with each other that can be used in the present disclosure is not limited to the above-described pressure-bonding. Any means may be applicable as long as it can electrically connect the electrode terminal (electrode) and the wiring.

The electric connection by the pressurization is an effective means in the present disclosure; however, in a case of the pressurization, a problem that the protection film is damaged may occur. For example, it is a case as follows. In the present disclosure, in order to achieve the electric conduction between the electrode terminal on the element substrate and the wiring of the substrate (flexible substrate), a through-hole (an opening of the protection film) is formed by forming a through hole in the protection film in the electrode terminal. The vicinity of the through-hole is a recess portion, and in a case of using a means such as the pressure-bonding, the distortion of the load due to the pressurization is most likely to concentrate, and the protection film is likely to be damaged.

In addition, there is also a problem as follows regarding the damage of the protection film. In the liquid ejection head in which the electric connection with the external circuit is performed by a plating bump provided on the element substrate, although there is no restriction on the size and the lamination form of the electrode terminal, the size of the electrode terminal is small in a case where an interval between the electrode terminals is a narrow pitch. Therefore, in the element substrate of the above-described form, it is difficult to increase the thickness by laminating plating and the like. Additionally, in a case where the thickness of the multilayer body including a plating layer is increased, the contact between the electrode terminal and the wiring achieved by the pressure-bonding is varied. In addition, there is also a problem of cost increase in a case where the electrode size is increased by the plating and the like. Additionally, in a configuration of the narrow pitch, although it is general to apply an electric connection method that uses thermosetting resin such as the non-conductive resin, there has been a demand for a solution to the problem that the protection film in the vicinity of the through-hole is damaged in a configuration of sandwiching the resin material.

Therefore, in a configuration in which the electrode terminal on the element substrate and the wiring of the substrate extending from the external circuit are electrically connected to each other by using the thermosetting resin material such as the non-conductive paste (NCP) or the non-conductive film (NCF) that allows the electric connection by using the non-conductive resin and the anisotropic conductive paste (ACP) or the anisotropic conductive film (ACF) that allows the electric connection by using the anisotropic conductive material, there has been a demand for suppression of the damage of the protection film in the vicinity of the through-hole in a case of connecting the electrode terminal (electrode) and the wiring. Particularly, there has been a demand for suppression of the damage of the protection film in the vicinity of the through-hole caused by the effect of the load due to the pressurization in a case of the pressure-bonding using the pressure-bonding tool as a means for the connection.

In a case where the electrode terminal (electrode) and the wiring are electrically connected to each other in the liquid ejection head using a method of ejecting the liquid from the ejection port with heat energy generated by the energy element, many methods such as gang bonding and wire bonding are used for the electric connection. On the other hand, in a case of a method of ejecting the liquid by deforming the shape of the energy element, a distance between the electrodes is narrowed in some cases, and the connection method is limited. In this case, bonding using the NCP as described above is used instead of the gang bonding.

In an example in which the electrode is bonded using the NCP, the resin material is sandwiched between the element substrate and the substrate (flexible substrate). In this case, the electrode is abutted through the resin material, and the resin is thermally cured in this state. Accordingly, in the bonding of the electrode using the NCP, the damage on the electrode is small, unlike the configuration in which intermetallic bonding is performed by the gang bonding or the wire bonding with heat and pressure or ultrasonic waves. It should be noted that, as for the electrode, the electrode size is small because the interval between the electrodes is narrow. In addition, because of an aspect ratio in a case of forming the plating, the thickness is also limited, and the electrode is vulnerable to damage. A general pitch between the electrodes in the bonding using the NCP is approximately 38 μm, and an electrode width in a pitch direction is approximately 25 μm. Additionally, a wiring width facing the electrode is approximately 10 μm.

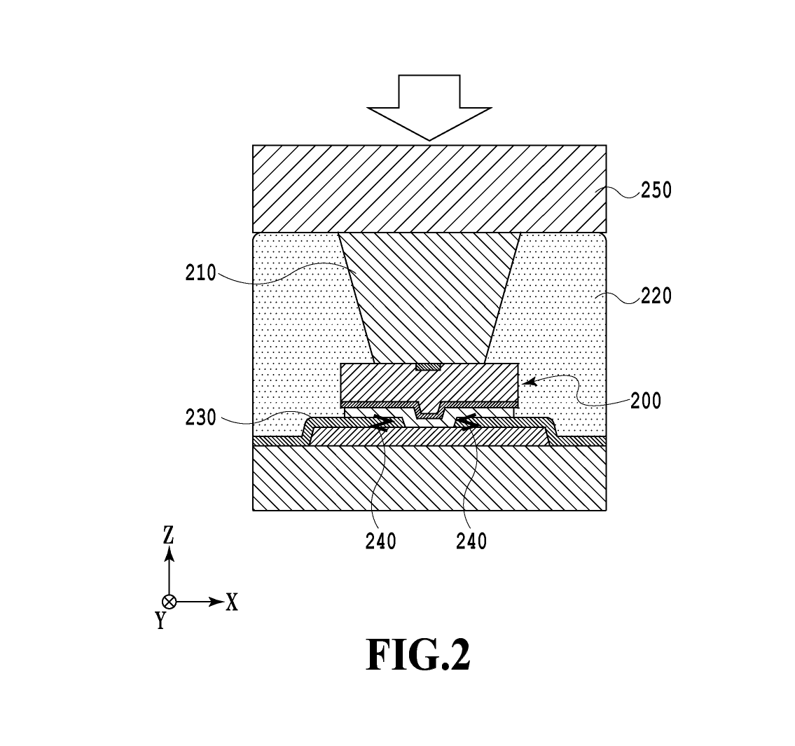

Therefore, in the present disclosure, the damage on the protection film is suppressed in the form of bonding to perform the electric connection by sandwiching the resin material between the electrodes. Note that, hereinafter, a case where the electric connection is performed by using the pressure-bonding method performed by heat, pressing, and the like is described as an example. The damage on the protection film is illustrated in FIG. 2. As illustrated in FIG. 2, the bonding of the electrode is performed by applying heat, pressing (arrow direction), and the like to the wiring 210 so as to be pressed onto the electrode terminal 200 via a resin material 220. In a case where the element substrate (chip) including a through-hole therein and a protection film 230 is positioned below the electrode terminal 200, there is a possibility that a damage portion 240 is formed in the protection film 230 in the vicinity of the through-hole by the pressure during the bonding. The present disclosure suppresses the damage of the protection film 230.

### Configuration of Electrode Terminal on Element Substrate

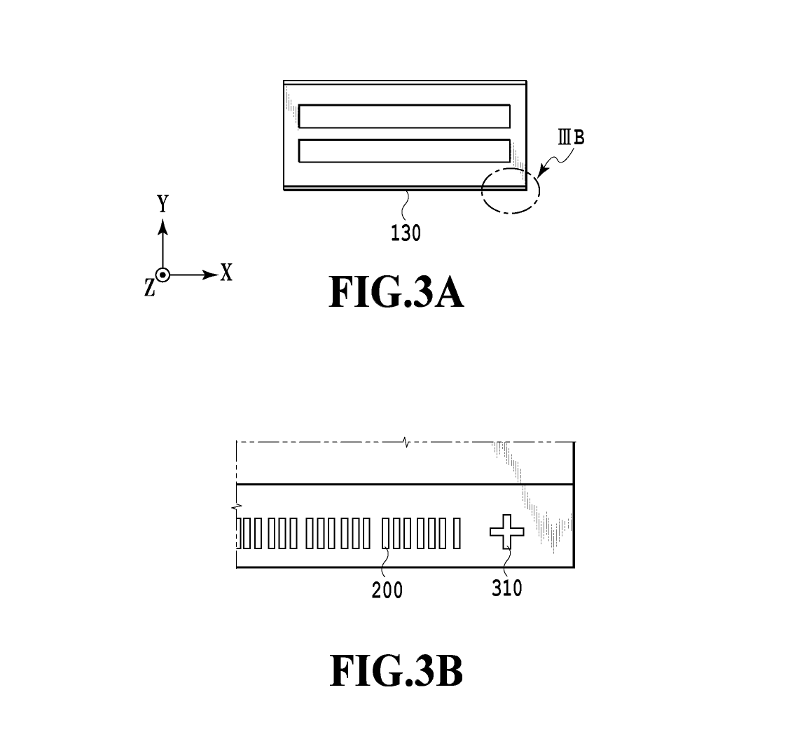

Hereinafter, a configuration of a general electrode used as the electrode terminal 200 in the element substrate 130 of the liquid ejection head used in the liquid ejection apparatus of the above-described configuration is described with reference to FIGS. 3 to 5.

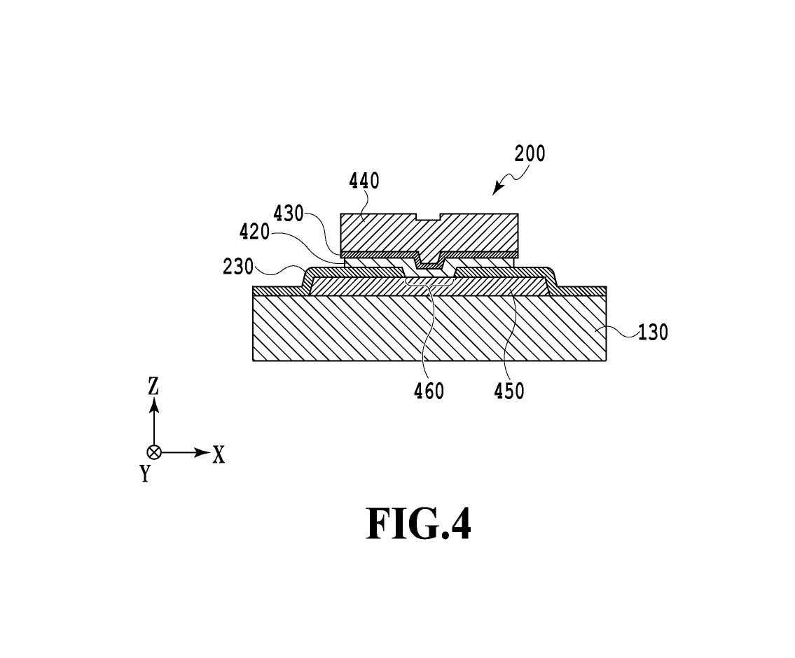

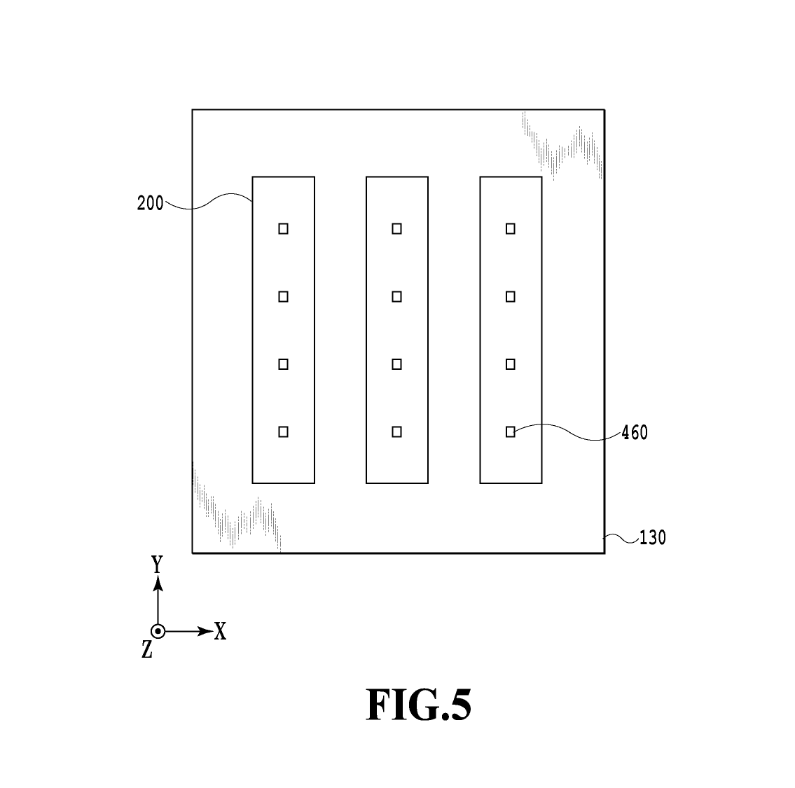

FIG. 3 is a plan view of the element substrate 130 in the liquid ejection head. FIG. 4 is a cross-sectional view of the electrode terminal 200 of the element substrate 130, and FIG. 5 is a plan view of the electrode terminal 200 of the element substrate 130.

FIG. 3A is a plan view of the element substrate 130 of the present disclosure, and FIG. 3B is an enlarged view of a IIIB portion of the element substrate 130. In the enlarged portion, the electrode terminal 200 and an alignment mark 310 on an element substrate side are arranged.

As illustrated in FIG. 4, in the element substrate 130, electric wiring 450 is provided on one surface of a silicon substrate. The electric wiring 450 is circuit wiring formed of aluminum that is patterned on the surface of the silicon substrate. The protection film 230 is formed on surfaces of the silicon substrate and the electric wiring 450. As illustrated in FIG. 4, the protection film 230 includes a region covering the electric wiring 450 and an opening exposing the electric wiring 450. The protection film 230 is configured to protect the electric wiring 450 from a liquid (for example, the ink, water in the air, and the like). The protection film 230 is formed of material such as silicon nitride (SiN) or silicon carbide (SiC). The material has a characteristic that it is hard yet brittle.

In the liquid ejection head of the present disclosure, the element substrate 130 includes the electrode terminal 200 including metal plating. In order to provide the electrode terminal including the metal plating on the protection film 230, a through-hole 460 is provided. The through-hole 460 can be formed by patterning the protection film 230 by a photolithography technique. Specifically, the electric wiring 450 is formed on the silicon substrate, and the protection film 230 is formed on the silicon substrate including the electric wiring. With the photolithography method, the through hole (opening) may be provided to expose the electric wiring 450 by removing the protection film 230 in the shape of the through-hole 460. The through-hole 460 makes it possible to obtain the electric conduction to the electric wiring 450 below the protection film 230. In the through-hole 460, an adhesion improving layer 420 such as TiW is formed on the electric wiring 450. The adhesion improving layer 420 is provided so as to spread into a desired shape of the electrode terminal. The electrode terminal is formed by providing a metal plating layer 440 of gold or the like is provided on a surface of the adhesion improving layer 420. Here, in terms of adhesion, after a plating undercoat layer 430 of gold or the like is molded by a PVC technique, an electrolytic plating layer of gold or the like is provided on the uppermost surface, and the electrode terminal 200 is formed. FIG. 5 illustrates the shapes of the electrode terminal 200 and the through-hole 460 on the manufactured element substrate 130. In the present embodiment, the size in a length direction (the Y axis direction in FIG. 5) perpendicular to a width direction (X axis direction) of the electrode terminal is approximately 150 μm, and the dimension of the opening of the through-hole 460 is approximately 5 μm square. In one embodiment, one or more through-holes can be provided below the electrode terminal.

### Configuration of Wiring Substrate (Flexible Substrate)

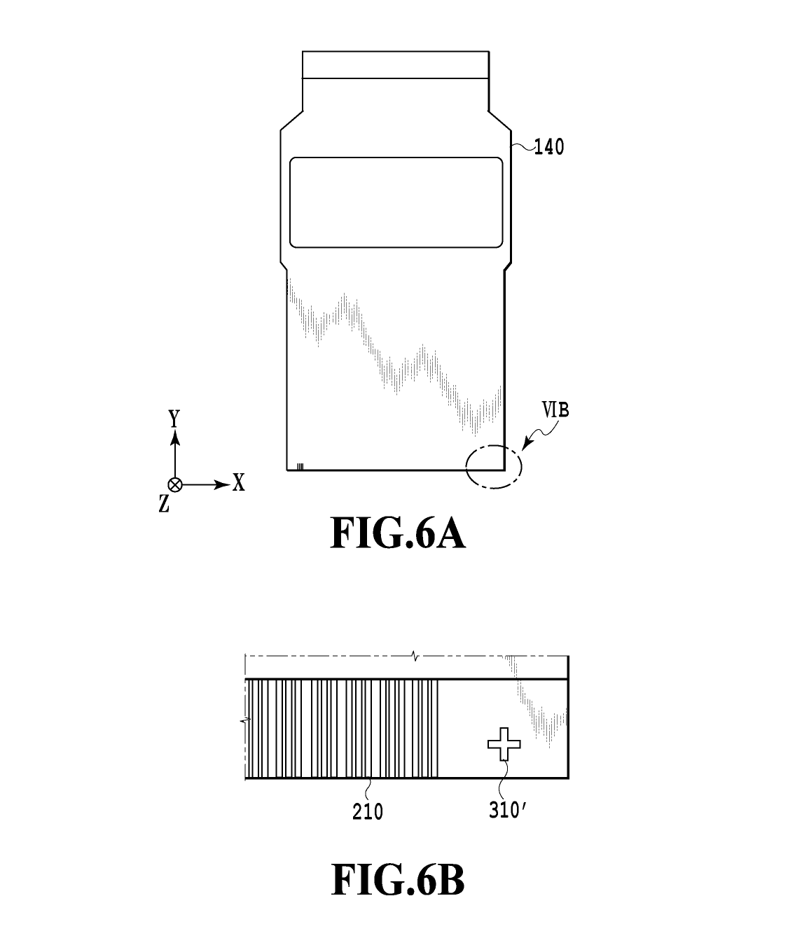

Hereinafter, a general configuration of the wiring substrate (hereinafter, also referred to as flexible substrate) 140 electrically connected to the element substrate 130 that is used in the liquid ejection apparatus of the above-described configuration is described with reference to FIGS. 6 to 8.

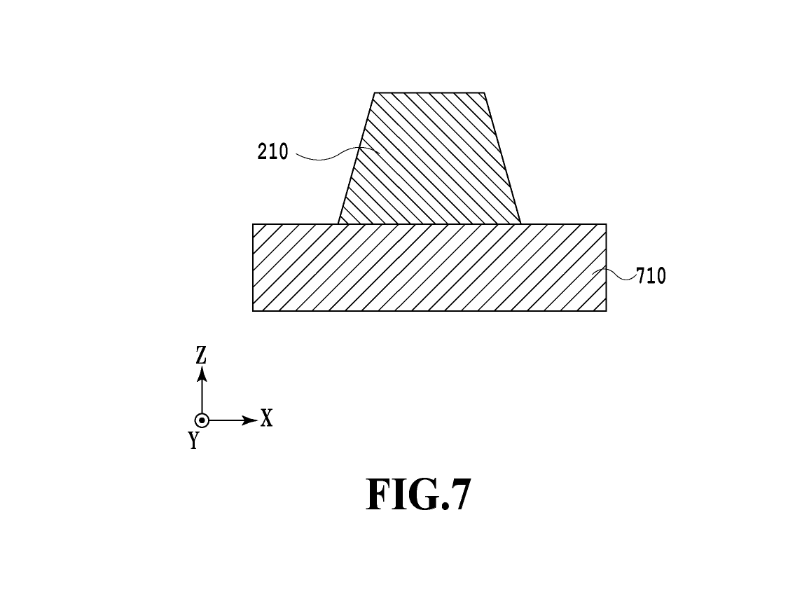

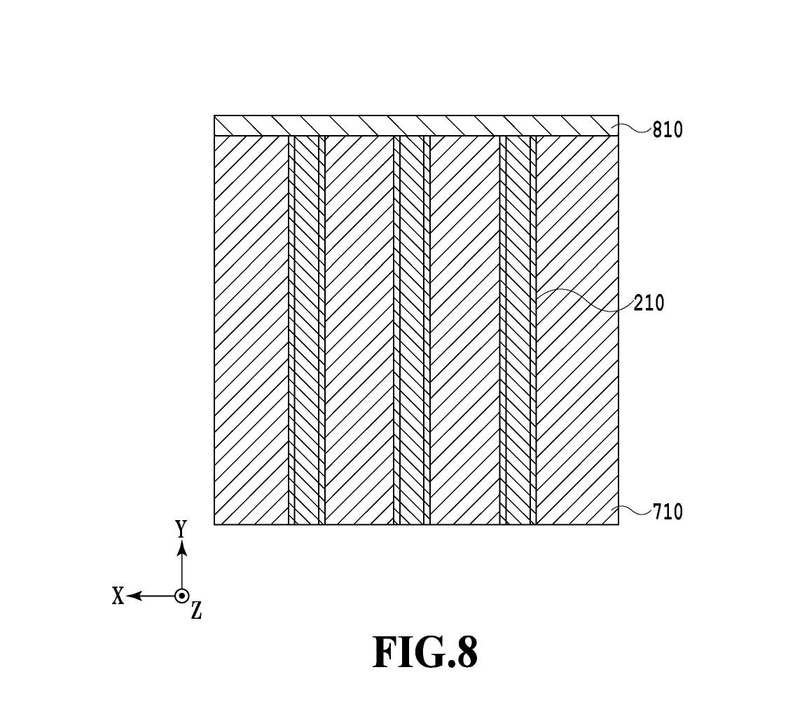

FIG. 6 is a plan view of the flexible substrate 140 extending from the outside in the liquid ejection head. FIG. 7 is a cross-sectional view of the wiring 210 of the flexible substrate 140 extending from the outside. In addition, FIG. 8 is a plan view of the wiring 210.

The liquid ejection head of the present disclosure includes the flexible substrate 140 illustrated in FIG. 6A. As illustrated in FIG. 6B, the substrate includes an alignment mark 310' and the wiring 210 at one end of the flexible substrate 140. The electrode terminal 200 of the element substrate 130 and the wiring 210 of the flexible substrate 140 are connected to each other by positioning the alignment mark 310 of the element substrate 130 described above (see FIG. 3) and the alignment mark 310' of the flexible substrate 140.

As illustrated in FIG. 7, in the substrate (flexible substrate) 140 extending from the outside, the wiring 210 is provided on one surface of a base film 710 formed of bendable polyimide. The wiring 210 is formed of metal such as copper and patterned as the electric wiring. On the base film provided with the wiring 210, an adhesion improving layer (not illustrated) of Ni or the like is formed thinly, and the entire base film including the wiring is covered. On a surface of the adhesion improving layer, metal plating (not illustrated) of gold or the like is provided to cover the wiring 210.

The wiring 210 and the layer covering the wiring 210 are provided on the base film 710 such that no electric conduction is established between the adjacent pieces of wiring 210. Additionally, a region that is not used for the electric connection is covered with resist 810 having the insulation properties (see FIG. 8). With the resist, the wiring 210 is exposed in only an end portion of the flexible substrate (the substrate extending from the outside) 140.

In the element substrate 130 and the wiring 210 of the present disclosure, multiple electrode terminals and wiring can be provided, and the interval between the provided electrode terminals and wiring can be a pitch of 100 μm or smaller.

### First Embodiment

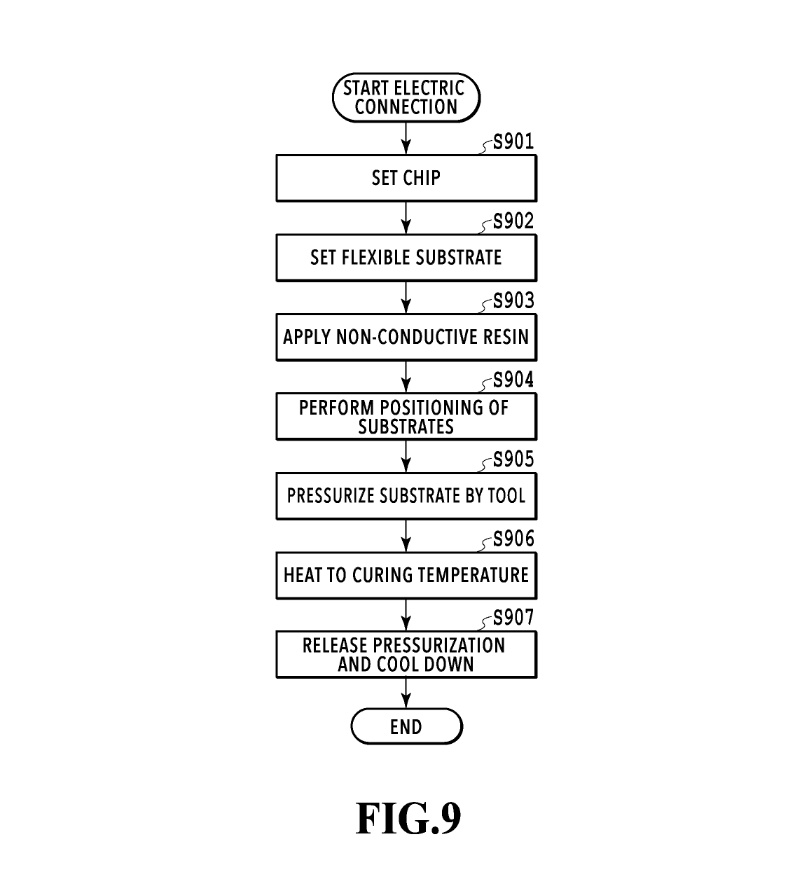

Hereinafter, regarding a first embodiment according to the present disclosure, a procedure is specifically described with reference to FIGS. 9 to 19. In the first embodiment, an example using the pressurization component, for example, the pressure-bonding tool is used as the tool (connection tool) configured to connect the electrode terminal (electrode) and the wiring is described. In the present disclosure, the tool configured to connect the electrode terminal (electrode) and the wiring is not limited to the pressure-bonding tool. Any connection tool may be utilized as long as it is possible to perform the electric connection between the electrode terminal (electrode) and the wiring and it is possible to suppress the damage of the protection film in the vicinity of the opening in a case where the electrode terminal (electrode) and the wiring are put in contact with each other.

FIG. 9 is a flowchart illustrating a method of the electric connection in the first embodiment. The corresponding steps are steps S901 to S907 illustrated in FIG. 9.

The element substrate 130 of the liquid ejection head is obtained as a diced chip obtained by cutting silicon wafers, by dicing, on which patterning and the like of the circuit wiring, the energy element, and the like are performed and laminated by pasting together. The element substrate 130 includes the energy element used to eject the liquid, and the energy element uses a piezo element as a piezoelectric element that is deformed by applying a voltage. It is possible to eject the liquid as needed by applying kinetic energy caused by the deformation of the piezo element to the liquid. In the present embodiment, the performance of the element substrate 130 is 1200 dpi. In addition, multiple electrodes of the number required for pairing up are provided to two sides of the element substrate 130, respectively, and it is possible to perform printing at 1200 dpi. Therefore, many pieces of wiring 210, the number is 600 or more, are provided to the element substrate 130 of a length of approximately 25 mm × 12 mm. Accordingly, the electrodes are provided at a narrow pitch. The interval of the narrow pitch is 100 μm or smaller, and in the present embodiment, the interval is about 40 μm.

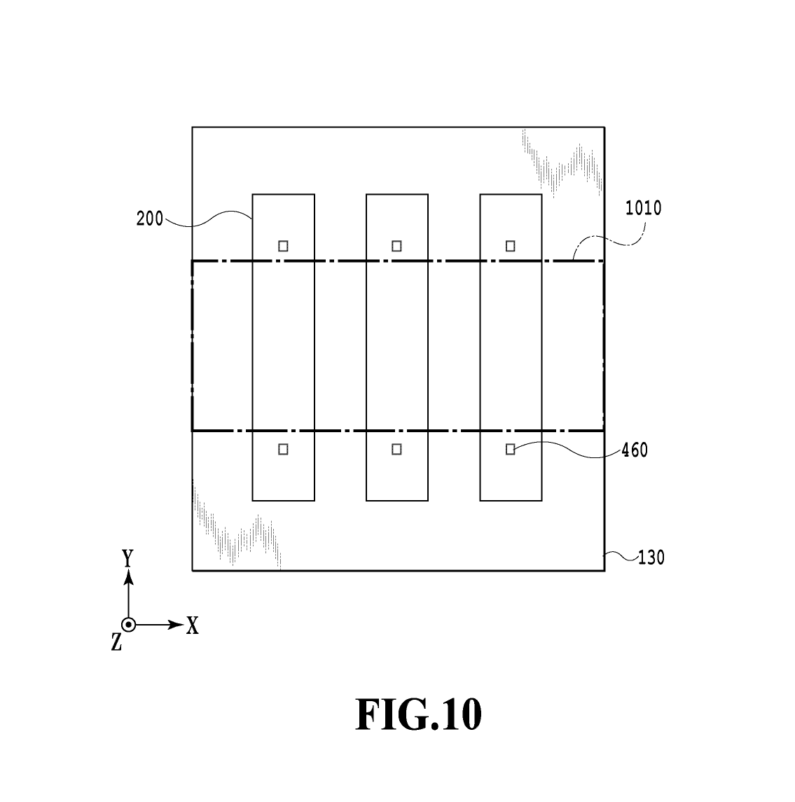

FIG. 10 is an arrangement view of the through-hole 460 provided in the electrode terminal 200 on the element substrate 130 in the first embodiment. In the first embodiment, in a case of pressurizing the flexible substrate 140 by the load of the connection tool (pressurization component, pressure-bonding tool) 250 for connecting the electrode terminal (electrode) and the wiring, a region (hereinafter, also referred to as an abutting region) in which the flexible substrate 140 and the tool 250 are put in contact with each other is pressurized. In the present specification, a region in which a pressure is applied to the abutting region by the tool 250 is referred to as a pressurization region (or a contact region) 1010. The load is transferred to the electrode terminal 200 on the chip 130 through the flexible substrate 140. The pressure applied to the pressurization region (contact region) 1010 is propagated while maintaining the size range of the tool 250. Therefore, the abutting region of the tool 250 is transferred directly in a perpendicular direction, and thus the pressurization region (contact region) 1010 of the electrode terminal 200 is formed. The through-hole 460 is arranged in front and rear of the pressurization region so as not to include the through-hole 460 in the pressurization region (contact region) 1010. Thus, the opening of the through-hole 460 and the pressurization region (contact region) 1010 are positioned so as not to overlap each other while viewing from a direction perpendicular to the element substrate 130 (Z axis direction). Here, in the present embodiment, the pressurization region (abutting region, contact region) between the electrode terminal of the element substrate 130 and the wiring of the flexible substrate 140 is comparable to a pressure-bonding region thereof. In the present embodiment, the size of the through-hole 460 is 5 μm square. Additionally, the more the through-holes 460 provided, the higher the formation speed of the adhesive layer formation, but the lower the reliability of the protection film 230. The same applies to the size of the through-hole 460, and the greater the size of the through-hole 460, the higher the formation speed of the adhesive layer formation, but the lower the reliability of the protection film 230. In the first embodiment, two through-holes 460 are provided as illustrated in FIG. 10; however, the number is not limited as long as one or more through-holes 460 are provided in a region other than the abutting region (or the contact region or the pressurization region).

In the present disclosure, the pressurization region (contact region) 1010 and the opening of the protection film 230 (the opening of the through-hole 460) can have a positional relationship at an interval of 5 μm or greater. Additionally, the opening of the protection film 230 (the opening of the through-hole 460) can have an area that is 30% or less of the area of the electrode terminal 200.

As illustrated in the steps S901 and S902 in FIG. 9, the chip (element substrate) 130 and the flexible substrate 140 are set to a bonding device for the electric connection. The flexible substrate 140 is the substrate extending from the outside to electrically connect the chip (element substrate) 130 with the outside.

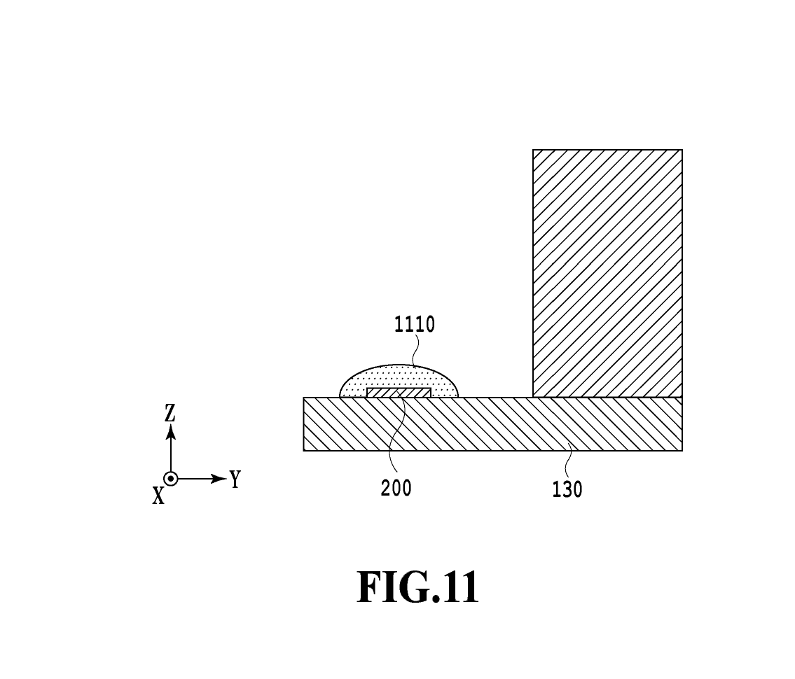

The step S903 in FIG. 9 is a step to apply non-conductive resin 1110 onto a surface of the chip (element substrate) 130 including the electrode terminal 200. As illustrated in FIG. 11, the NCP 1110, which is the non-conductive resin, is applied to cover the electrode terminal 200. An application amount of the NCP in this process is desirably an amount that is equal to or greater than the amount that can fill a space between the electrode terminal 200 on the chip (element substrate) 130 and the wiring 210 of the flexible substrate 140 so as to prevent electric failure between the pieces of wiring 210.

The step S904 in FIG. 9 is a step to align the alignment marks 310 and 310' (see FIGS. 3 and 6) in the respective two components, which are the electrode terminal 200 on the chip (element substrate) 130 and the wiring 210 of the flexible substrate 140, so as to align the positions of the two components. With the step being performed accurately, it is possible to perform the electric connection properly between the electrode terminal 200 and the wiring 210.

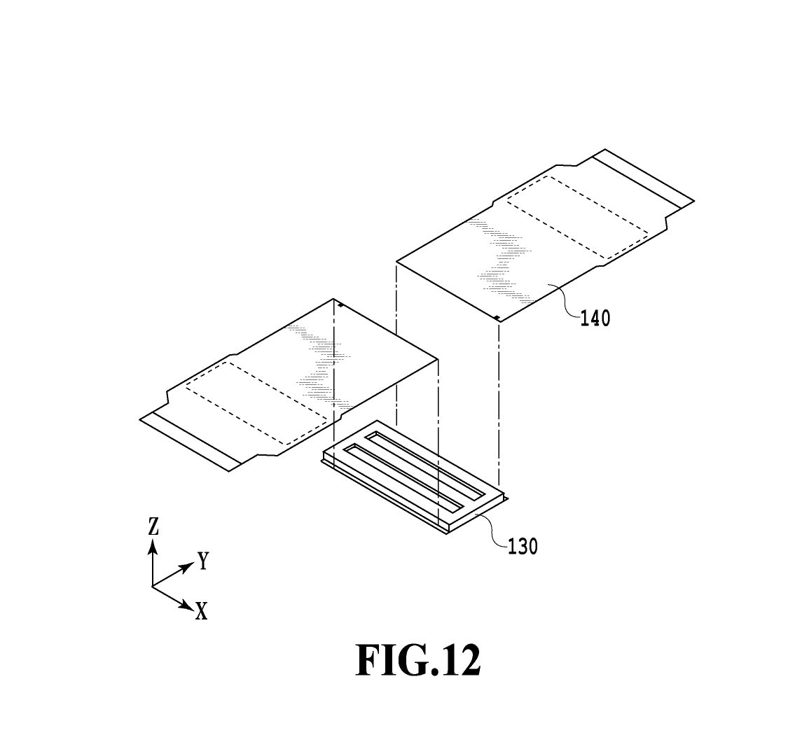

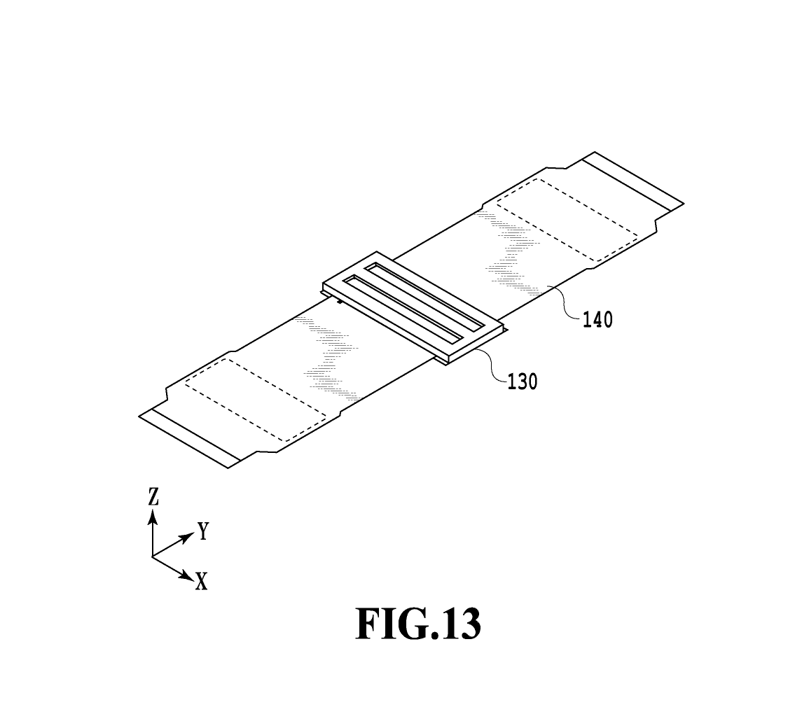

The step S905 in FIG. 9 is a step to pressurize the electrode terminal 200 on the chip (element substrate) 130 and the wiring 210 of the flexible substrate 140 by the tool 250 of the bonding device to abut to each other to paste together. As illustrated in FIG. 12, the connection is achieved by moving the flexible substrate 140 in the Z axis direction to the surface of the chip (element substrate) 130 on which the electrode is provided. A chip unit including the chip (element substrate) 130 and the flexible substrate 140 after the connection is obtained. The chip unit after the connection is illustrated in FIG. 13.

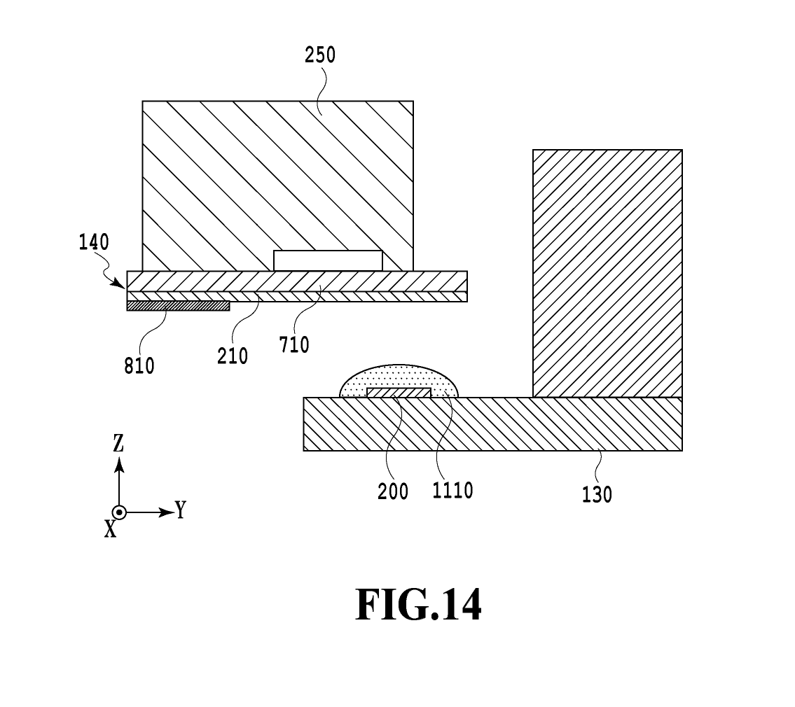

FIG. 14 is a diagram illustrating a state before the bonding by the pressure-bonding between the chip (element substrate) 130 and the flexible substrate 140. As illustrated in FIG. 14, the wiring 210 of the flexible substrate 140 is positioned on the chip (element substrate) 130 to which the NCP 1110 is applied to cover the electrode terminal 200 and pressurized by the tool 250, and thus the chip (element substrate) 130 and the flexible substrate 140 are bonded.

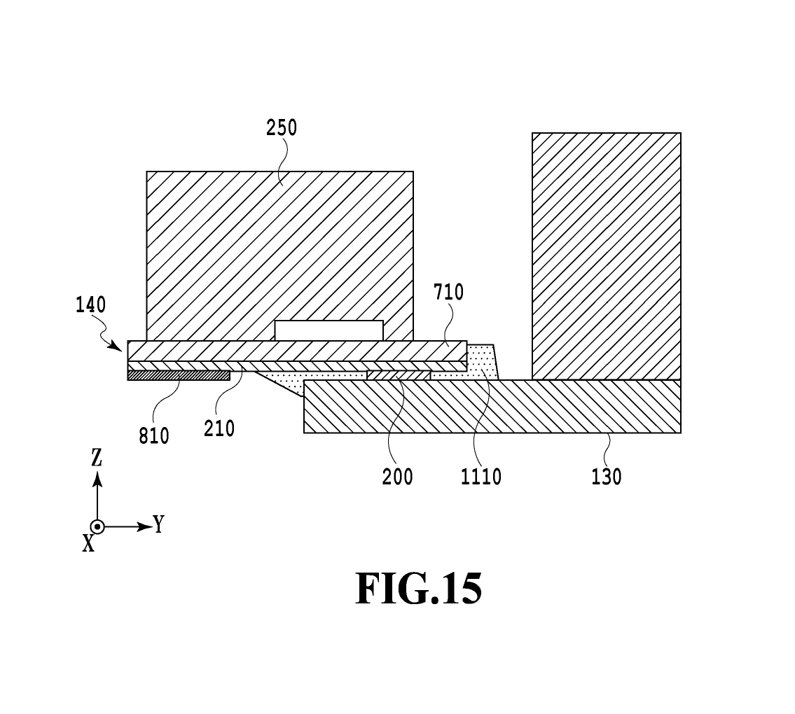

FIG. 15 is a diagram illustrating a state after the bonding between the chip (element substrate) 130 and the flexible substrate 140. As illustrated in FIG. 15, the NCP 1110 is filled in a space around a connection region between the electrode terminal 200, the chip (element substrate) 130, and the flexible substrate 140. Thus, the chip (element substrate) 130 and the flexible substrate (substrate) 140 bonded by the resin material, and the chip (element substrate) 130 and the flexible substrate (substrate) are electrically connected to each other with the electrode terminal and the wiring overlapping each other in a facing state.

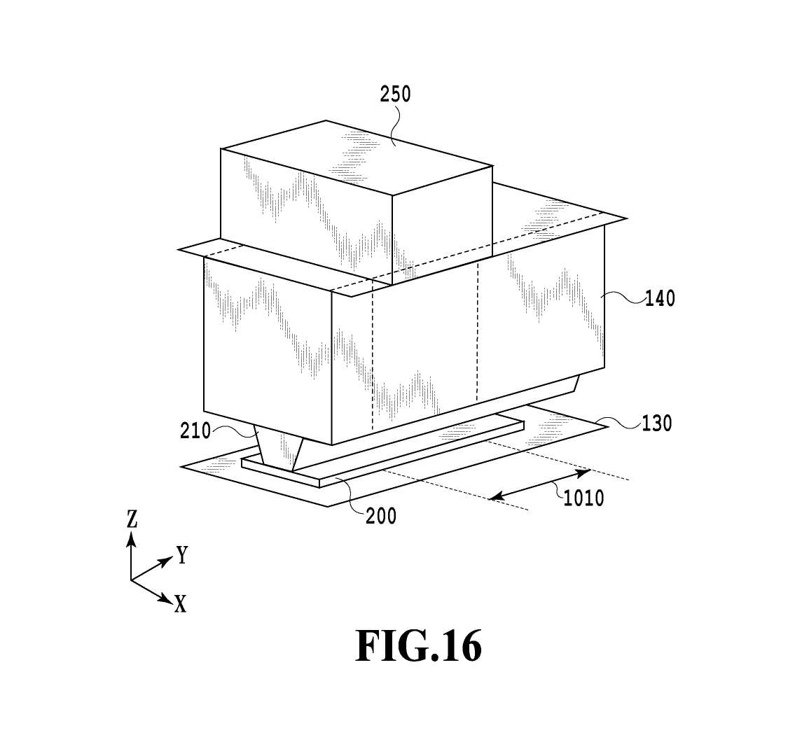

FIG. 16 is a schematic view illustrating the tool 250 and the pressurization region (contact region) 1010. FIG. 16 illustrates a relationship between the tool 250 and the pressurization region (contact region) 1010 in the bonding between the chip (element substrate) 130 and the flexible substrate 140. As illustrated in FIG. 16, although the flexible substrate 140 that is in contact with the tool 250 is pressurized, the pressurized portion is a portion of the pressurization region (contact region) 1010. The load of the tool 250 is transferred from the abutting region of the tool 250 (the region in which the tool 250 and the flexible substrate 140 are in contact with each other) in the Z axis direction, and the region 1010 that is pressurized is formed in the electrode terminal 200 via the wiring 210.

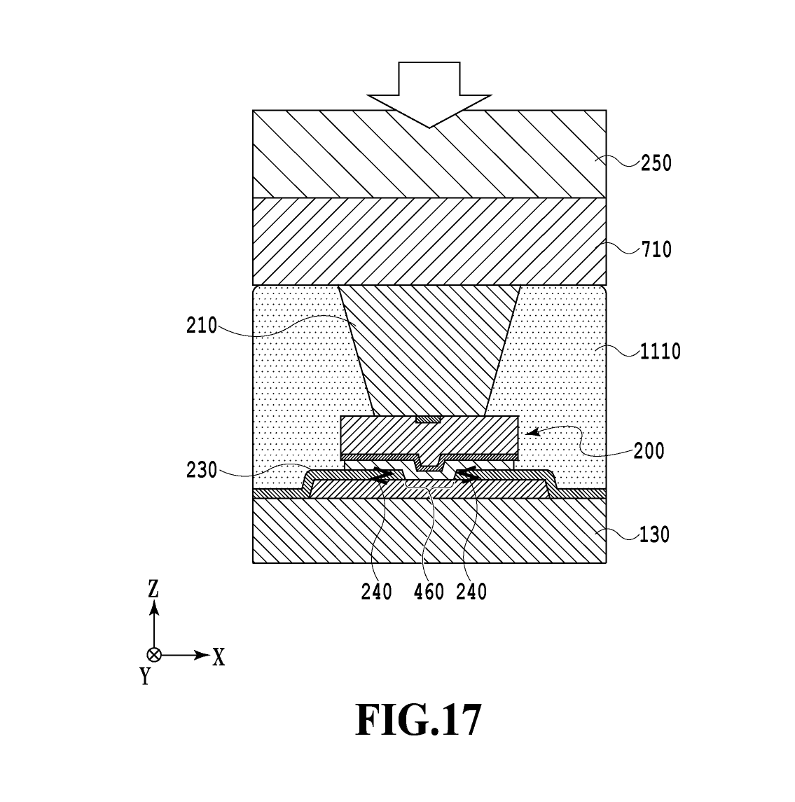

An example of a case where the region including the through-hole 460 provided to the electrode terminal 200 and the pressurization region (contact region) 1010 overlap each other is described with reference to FIG. 17. FIG. 17 is a cross-sectional view of the above example. The region of the through-hole 460 is the recess portion as illustrated in FIG. 17, and stress is likely to concentrate in a case of the pressurization. In addition, as described above, since multiple layers of metal and the like are laminated, the distortion against the pressure is varied on the multilayer body. For example, in the multilayer body of metal, the metal spreads by the pressure from the tool 250. In contrast, the protection film 230 formed of silicon nitride (SiN) is a hard material, and thus the protection film 230 spreads less than the multilayer body of metal does. Therefore, there is a possibility that the protection film 230 is damaged due to a difference between the spreading of the protection film 230 and the multilayer body of metal. This is because there is a possibility that a crack is generated in the protection film 230 due to the above-described spreading difference. Accordingly, in a case of the pressurization by the tool 250, the region including the through-hole 460 and the pressurization region (contact region) 1010 obtained by the tool 250 are desirably in positions not overlapping each other.

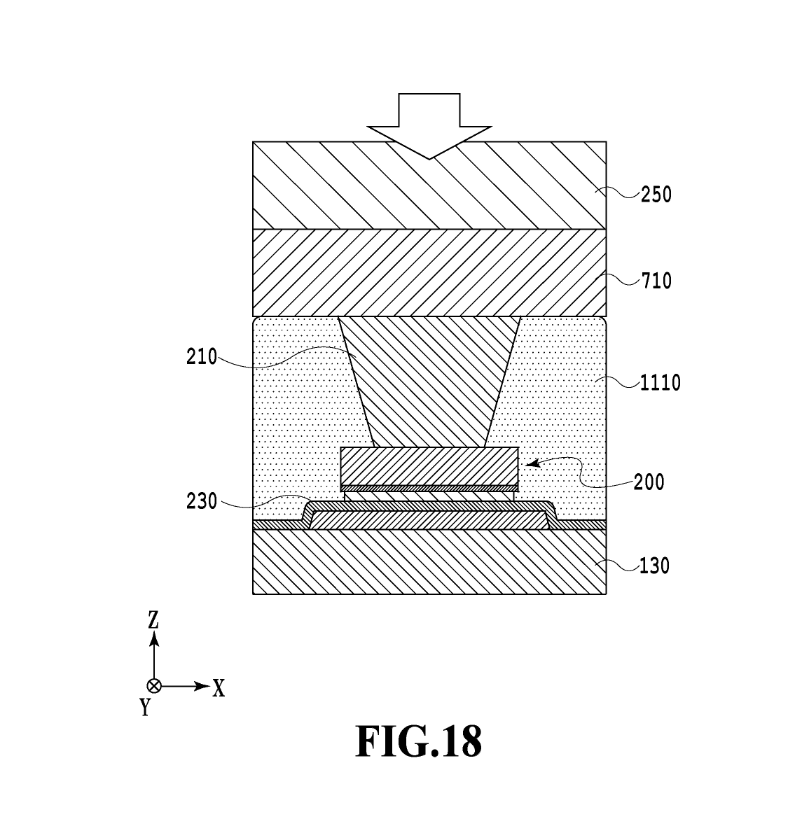

On the other hand, an example of a case where the region including the through-hole 460 provided to the electrode terminal 200 and the pressurization region (contact region) 1010 do not overlap each other is described with reference to FIG. 18. FIG. 18 is a cross-sectional view of the above-described example.

As illustrated in FIG. 18, in a case where the flexible substrate 140 is pressurized by the tool 250 in the region including no through-hole 460, since there is no recess portion in the position of the through-hole, the stress in a case exemplified in FIG. 17 does not concentrate, and uniform pressurization can be performed on the pressurization region (contact region). Therefore, the protection film 230 is less likely to be damaged. Note that, depending on the degree of the load, a thickness of each layer of the multilayer body including the metal plating layer, and the like, the resistance of the protection film 230 to the damage varies. Therefore, the load applied by the tool 250 is desirably not excessive. Particularly, the load is desirably within a range that allows the electrode terminal 200 of the chip (element substrate) 130 and the wiring 210 of the flexible substrate 140 to be put in contact with each other, but the protection film 230 is not damaged.

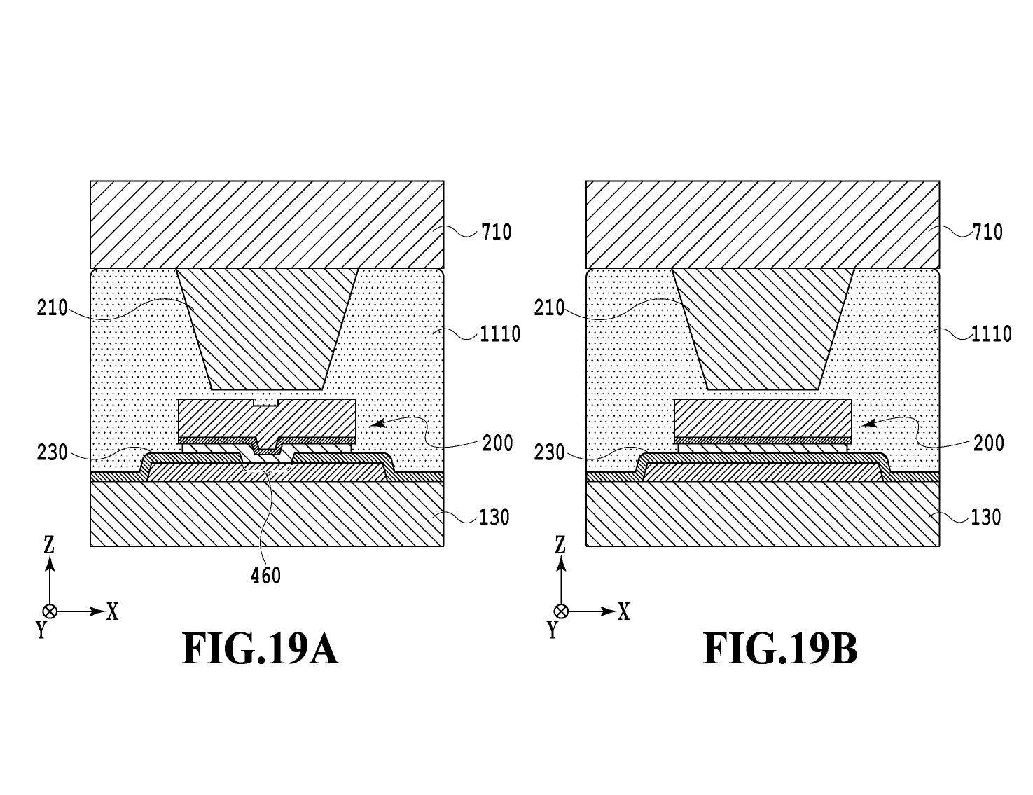

Additionally, cross sections of the portions that are not the abutting region obtained by the tool 250 are shown as FIGS. 19A and 19B. FIG. 19A is a cross-sectional view of a connection portion in the vicinity of the through-hole 460 provided outside the region (pressurization region (contact region) 1010) to which the load is applied by the tool 250. FIG. 19B is a cross-sectional view of a connection portion including no through-hole 460 in the outside of the region to which the load is applied by the tool 250.

The region illustrated in FIGS. 19A and 19B is not the pressurization region (contact region) 1010. Accordingly, even in a case where the pressure is applied by the tool 250, the force that puts the electrode terminal 200 and the wiring 210 in contact with each other through the NCP 1110 is not transferred. Therefore, as illustrated in FIGS. 19A and 19B, a state in which the NCP 1110 is filled in the space between the electrode terminal 200 of the chip (element substrate) 130 and the wiring 210 of the flexible substrate 140 is maintained. Unlike another connection method, the wiring 210 is unlikely to be deformed by the pressurization by the tool 250, and the region 1010 that is pressurized does not spread beyond the abutting region of the tool 250. Therefore, the load of the tool 250 is not directly transferred to the electrode terminal 200 outside the region (pressurization region (contact region) 1010) to which the load is applied by the tool 250. Therefore, it is possible to reduce the possibility that the electrode terminal 200 and the protection film 230 are damaged. Thus, the region including the opening (through-hole) of the protection film on the electrode terminal is filled with the resin material. This is a characteristic of the present embodiment in which the electrode terminal 200 and the wiring 210 are electrically connected to each other via the NCP 1110 (resin material 220).

The step S906 in FIG. 9 is a step to heat the chip (element substrate) 130 and the flexible substrate 140, which are put in contact with each other and pressurized, while sandwiching the NCP 1110 therebetween. In the present step, the electrode terminal 200 on the chip (element substrate) 130 and the wiring 210 of the flexible substrate 140, which are abutted to each other and pasted together, are heated. The NCP 1110 is formed of a thermosetting adhesive; for this reason, the NCP 1110 is cured by being heated to a temperature exceeding a curing temperature of the material. The heating temperature varies depending on a curing temperature of the non-conductive resin used, and it is desirably a temperature sufficient to cure the resin. In the process of heating and curing, it is desirable to maintain a pressurization state by the tool 250 to maintain an abutting state between the electrode terminal 200 of the chip (element substrate) 130 and the wiring 210 of the flexible substrate 140.

The step S907 in FIG. 9 is a step to release the load on the chip (element substrate) 130 and the flexible substrate 140 pasted together and cool down. In the present step, after the pasting of the electrode terminal 200 on the chip (element substrate) 130 and the wiring 210 of the flexible substrate 140 together is completed, the release of the load caused by the tool 250 and the cooling are performed on the cured product. The release of the load and the cooling can be performed by means known to the skilled in the art.

Through the above-described steps, it is possible to electrically connect the chip that is the element substrate 130 and the wiring 210 of the flexible substrate 140, and it is possible to create the chip unit that is a part of the liquid ejection head.

In the present embodiment, the magnitude relationship in the width between the electrode terminal 200 on the chip (element substrate) 130 and the wiring 210 of the flexible substrate 140 is that the wiring 210 is thin (about 10 μm) as illustrated in FIG. 16. However, in the present embodiment, the relationship may be an opposite relationship that the wiring 210 is thick.

### Effect of Present Embodiment

As described above, in the present embodiment, regarding the electrode terminal 200 on the chip (element substrate) 130, the through-hole 460 is provided such that the pressurization region (contact region) 1010 of the tool 250 and the region of the opening of the through-hole 460 do not overlap each other. Since the through-hole 460 is not affected by the load from the tool 250, it is possible to avoid the effect on the protection film 230 due to the concentration of the load and the like, and it is possible to suppress the damage of the protection film 230.

According to the present disclosure, in the electric connection using the resin material 220 (for example, the NCP 1110), it is possible to suppress the damage of the protection film 230 of the electrode terminal 200 on the element substrate 130, and it is possible to achieve improvement in the reliability of the liquid ejection head.

With the procedure illustrated in FIG. 9 described above, it is possible to manufacture the chip unit that is a part of the liquid ejection head of the present disclosure. Accordingly, the manufacturing method of the liquid ejection head of the present disclosure incorporates steps including the following characteristics.

(a) A step of covering the electrode terminal of the element substrate with a resin layer and positioning the wiring of the substrate to introduce to the bonding device.

(b) A step of bonding the electrode terminal and the wiring via the resin layer.

The manufacturing method is characterized in that, in the bonding step (step (b)), the bonding is the pressure-bonding performed by pressurization and heating, the contact region is the pressure-bonding region obtained by the pressure-bonding, and the opening of the protection film in the position overlapping the electrode is in the position not overlapping the contact region between the electrode and the wiring while viewing from the direction perpendicular to the element substrate.

### Second Embodiment

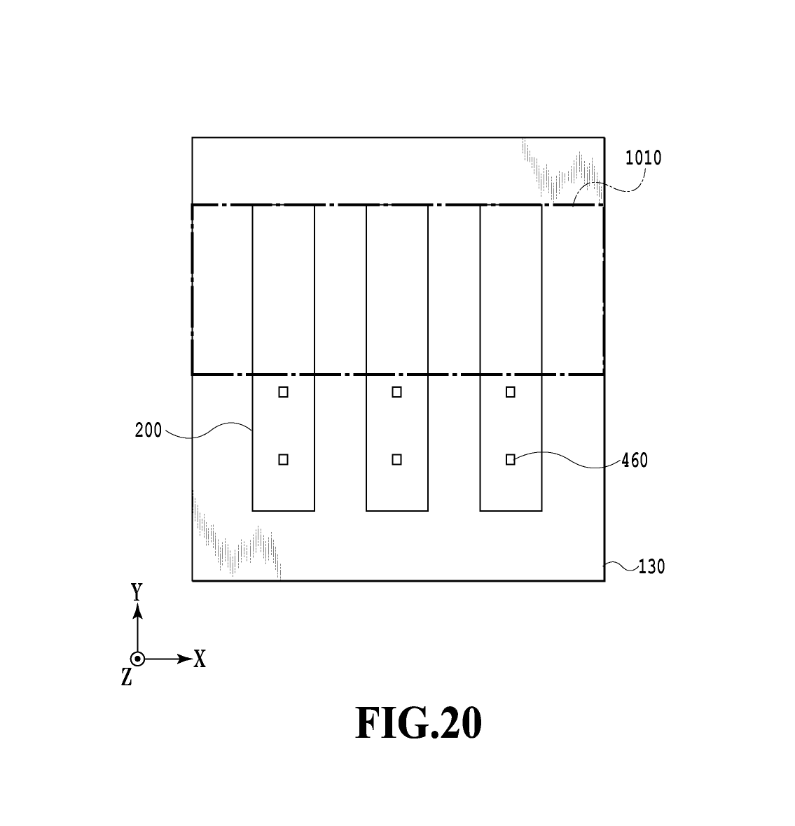

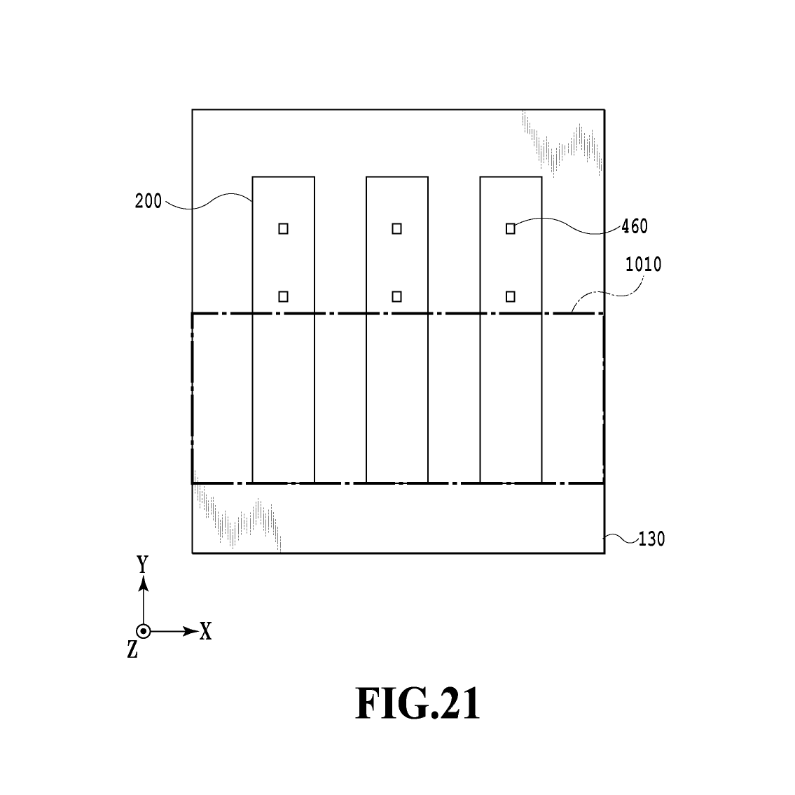

Hereinafter, a second embodiment according to the present disclosure is described with reference to FIGS. 20 to 21. Also in the second embodiment, the liquid ejection head of the present disclosure is described based on an example using the pressurization component, for example, the pressure-bonding tool as the tool (connection tool) configured to connect the electrode terminal (electrode) and the wiring. In the present embodiment, the tool configured to connect the electrode terminal (electrode) and the wiring is not limited to the pressure-bonding tool. Any connection tool can be utilized as long as it is possible to perform the electric connection between the electrode terminal (electrode) and the wiring and it is possible to suppress the damage of the protection film in the vicinity of the opening in a case where the electrode terminal (electrode) and the wiring are put in contact with each other.

The electric connection method in the second embodiment is as the flowchart in FIG. 9. The corresponding steps are the steps S901 to S907 illustrated in FIG. 9, and the chip that is the element substrate 130 and the flexible substrate 140 that is the substrate extending from the outside are set.

FIG. 20 is an arrangement view of the through-hole 460 on the electrode terminal 200 of the chip (element substrate) 130 in the second embodiment. The present example illustrated in FIG. 20 is an example in which two through-holes 460 are provided. The number of the through-holes 460 is not limited as long as one or more through-holes 460 are provide to the electrode terminal 200 to establish the electric conduction. In a case where the flexible substrate 140 is pressurized by the load of the tool 250, the load is propagated to the electrode terminal 200, and thus the pressurization region (contact region) 1010 is formed.

The NCP 1110 that is the resin material 220 covers the electrode terminal 200 in a case of being electrically connected onto the electrode terminal 200 of the chip (element substrate) 130. The amount required for the covering is applied. Thereafter, the positioning is performed by the alignment marks 310 and 310' (see FIGS. 3 and 6) of the element substrate and the flexible substrate, and thus the electrode terminal 200 and the wiring 210 are aligned at a position that allows for the electric connection.

Additionally, the electrode terminal 200 and the wiring 210 are abutted to each other by the pressurization by the tool 250. In this process, as illustrated in FIG. 20, the pressurization region (contact region) 1010 and the region provided with the through-hole 460 to which no load is applied are separated in front and rear on the electrode terminal 200 in the Y axis direction.

As another example of the present embodiment, the arrangement of the pressurization region (contact region) 1010 and the region provided with the through-hole 460 on the electrode terminal 200 may be arrangement as illustrated in FIG. 21 that is symmetrical to FIG. 20.

In the example of the present embodiment, the region provided with the through-hole 460 (the opening of the protection film) and the pressurization region (contact region) 1010 do not overlap each other. Therefore, it is possible to reduce the possibility that the stress concentrates on the through-hole 460, and the protection film 230 below the electrode terminal 200 is damaged.

Thereafter, the NCP 1110 (resin material 220) is cured by heating the substrate pasted together. The pressure and the temperature during the curing are selected as needed based on the material used by the skilled in the art. Next, the pressurization is stopped, the cooling is performed to complete the electric connection, and thus the chip unit can be obtained.

In the present embodiment, a magnitude relationship in the width between the electrode terminal 200 on the chip (element substrate) 130 and the wiring 210 of the flexible substrate 140 is that the wiring 210 is thinner than the electrode terminal 200 as illustrated in FIG. 16. However, the relationship may be an opposite relationship.

### Effect of Present Embodiment

As described above, in the present embodiment, regarding the electrode terminal 200 on the chip (element substrate) 130, the pressurization region (contact region) 1010 of the tool 250 is provided in a position not overlapping the region provided with the through-hole 460. Since the through-hole 460 is not affected by the load of the tool 250, it is possible to avoid the effect on the protection film 230 due to the concentration of the load and the like, and it is possible to suppress the damage of the protection film 230.

### Third Embodiment

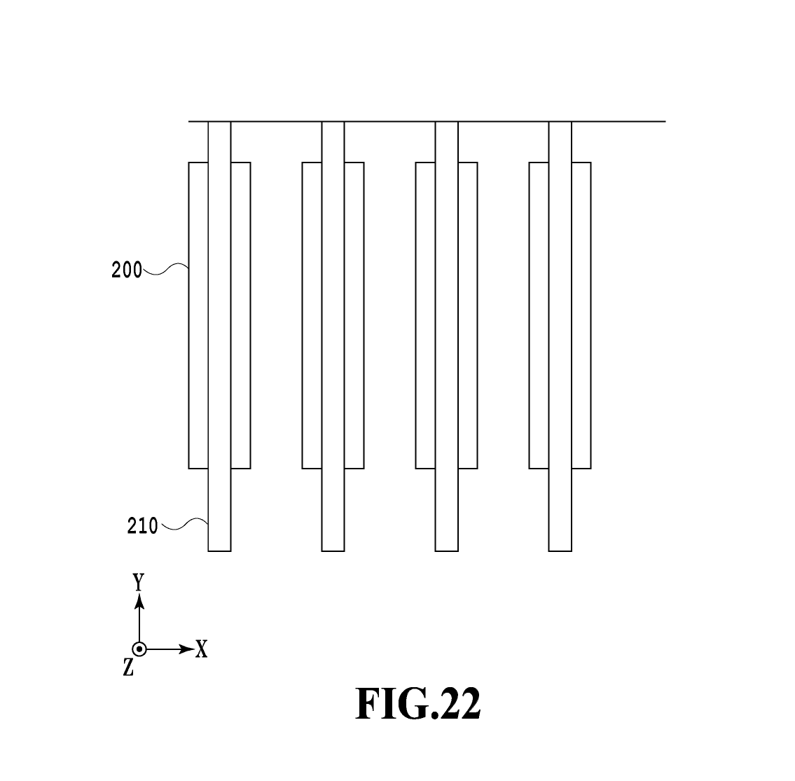

Hereinafter, a third embodiment according to the present disclosure is described with reference to FIGS. 22 to 26. Also in the present embodiment, an example using the pressurization component, for example, the pressure-bonding tool is used as the tool (connection tool) configured to connect the electrode terminal (electrode) and the wiring is described. In the present disclosure, the tool configured to connect the electrode terminal (electrode) and the wiring is not limited to the pressure-bonding tool. Any connection tool can be utilized as long as it is possible to perform the electric connection between the electrode terminal (electrode) and the wiring and it is possible to suppress the damage of the protection film in the vicinity of the opening in a case where the electrode terminal (electrode) and the wiring are put in contact with each other.

The electric connection method in the third embodiment is as the flowchart in FIG. 9. The corresponding steps are the steps S901 to S907 illustrated in FIG. 9, and the chip 130 that is the element substrate and the flexible substrate 140 that is the substrate extending from the outside are set to the bonding device.

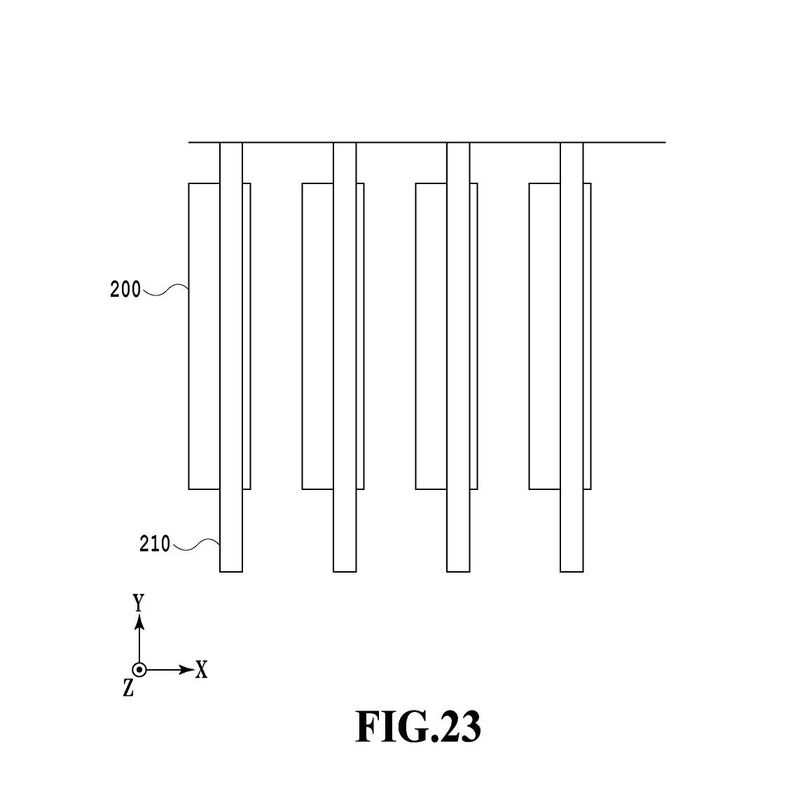

The wiring 210 of the flexible substrate 140 is formed by etching, and thus it is possible to form a surface that is abutted to the electrode terminal of the chip 130 to have a thin width. Therefore, as illustrated in FIG. 22, the width of the electrode terminal 200 can be formed wider than the wiring 210. In a case where the above-described wiring 210 is displaced in the +X direction as illustrated in FIG. 23, for example, a region other than a surface of the electrode terminal 200 that is abutted to the wiring 210 can be formed to have a wide width portion in the -X direction. The mode is similarly obtained by displacing the wiring 210 in the -X direction on the electrode terminal 200. In this state, also in a space beside (X axis direction) the abutting region between the electrode terminal 200 and the wiring 210, there is a region that is the pressurization region 1010 of the tool 250, but in which the wiring 210 is not abutted onto the electrode terminal 200. In the present embodiment, the through-hole 460 is arranged in the region that is the pressurization region of the tool 250, but is the region in which the wiring 210 is not abutted onto the electrode terminal 200 (the region in which the electrode terminal 200 and the wiring 210 do not overlap each other).

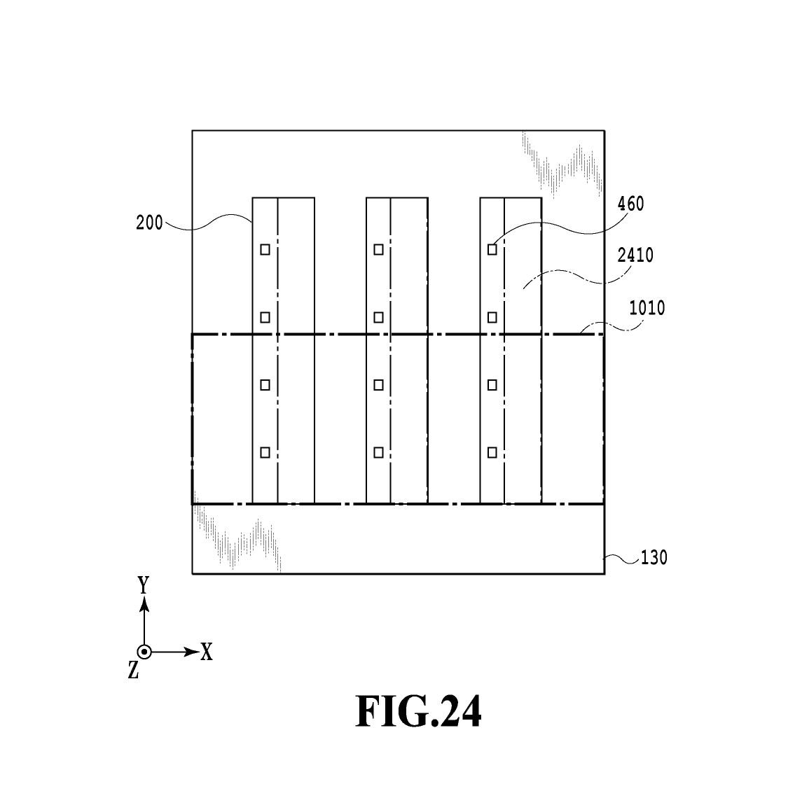

FIG. 24 is an arrangement view of the through-hole 460 on the electrode terminal 200 of the chip (element substrate) 130 in the third embodiment. Four through-holes 460 are provided in the example. An abutting region 2410 between the pressurization region (contact region) 1010 and the wiring 210 is arranged in the vicinity of an end portion (X axis direction) in either right or left of the electrode terminal 200, instead of the center of the electrode terminal 200. In the example illustrated in FIG. 24, the pressurization region (contact region) 1010 is in one half of the element substrate 130 in the Y axis direction (-Y direction). In the present embodiment, as illustrated in FIG. 24, the through-hole 460 is arranged in a region other than the region 2410 in which the electrode terminal 200 and the wiring 210 are abutted to each other. Specifically, as illustrated in FIG. 24, the through-hole 460 is arranged in a range of a width of the electrode terminal 200 in the -X direction.

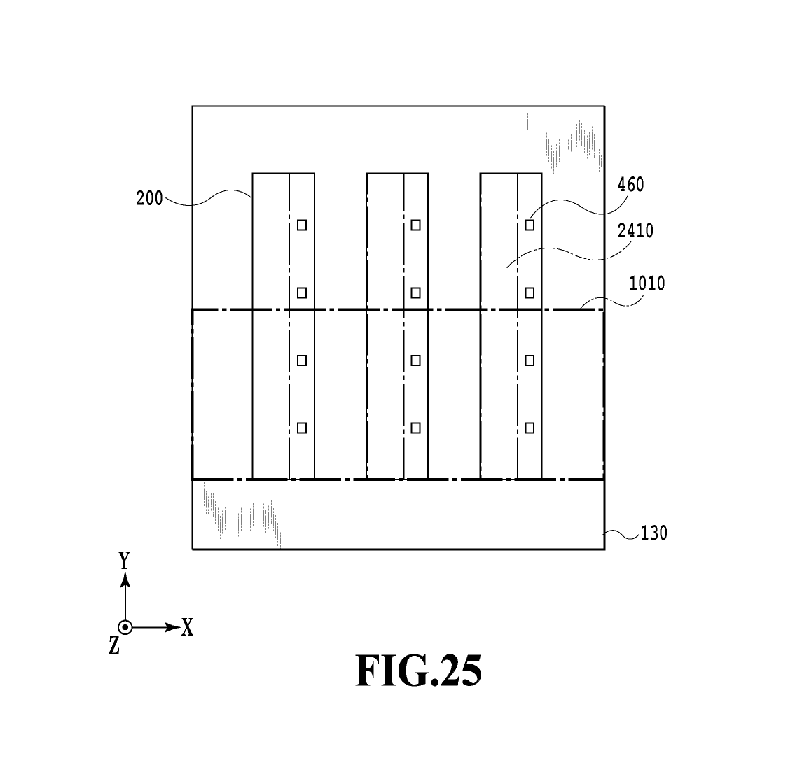

Another mode of the present embodiment is illustrated in FIG. 25. As illustrated in FIG. 25, the through-hole 460 is arranged in the region other than the region 2410 in which the electrode terminal 200 and the wiring 210 are abutted to each other. Specifically, as illustrated in FIG. 25, the through-hole 460 is arranged in the electrode terminal 200 in the +X direction. The through-hole 460 is provided in a symmetrical position with respect to the position illustrated in FIG. 24. Additionally, in the electrode terminal 200 in which the width of the electrode terminal 200 is wide, and there is an enough region to provide the through-hole 460, the abutting region 2410 between the electrode terminal 200 and the wiring 210 may be provided in the center of the electrode terminal 200. In this case, the through-holes 460 may be arranged on two out-sides of the abutting region 2410.

The NCP 1110 that is the resin material is applied onto the electrode terminal 200 of the chip (element substrate) 130. The application amount of the NCP 1110 is the amount required in a case of the electric connection. Thereafter, the positioning is performed by the alignment marks 310 and 310' of the substrates (see FIGS. 3 and 6), and the electrode terminal 200 and the wiring 210 are aligned at a position that allows for the electric connection.

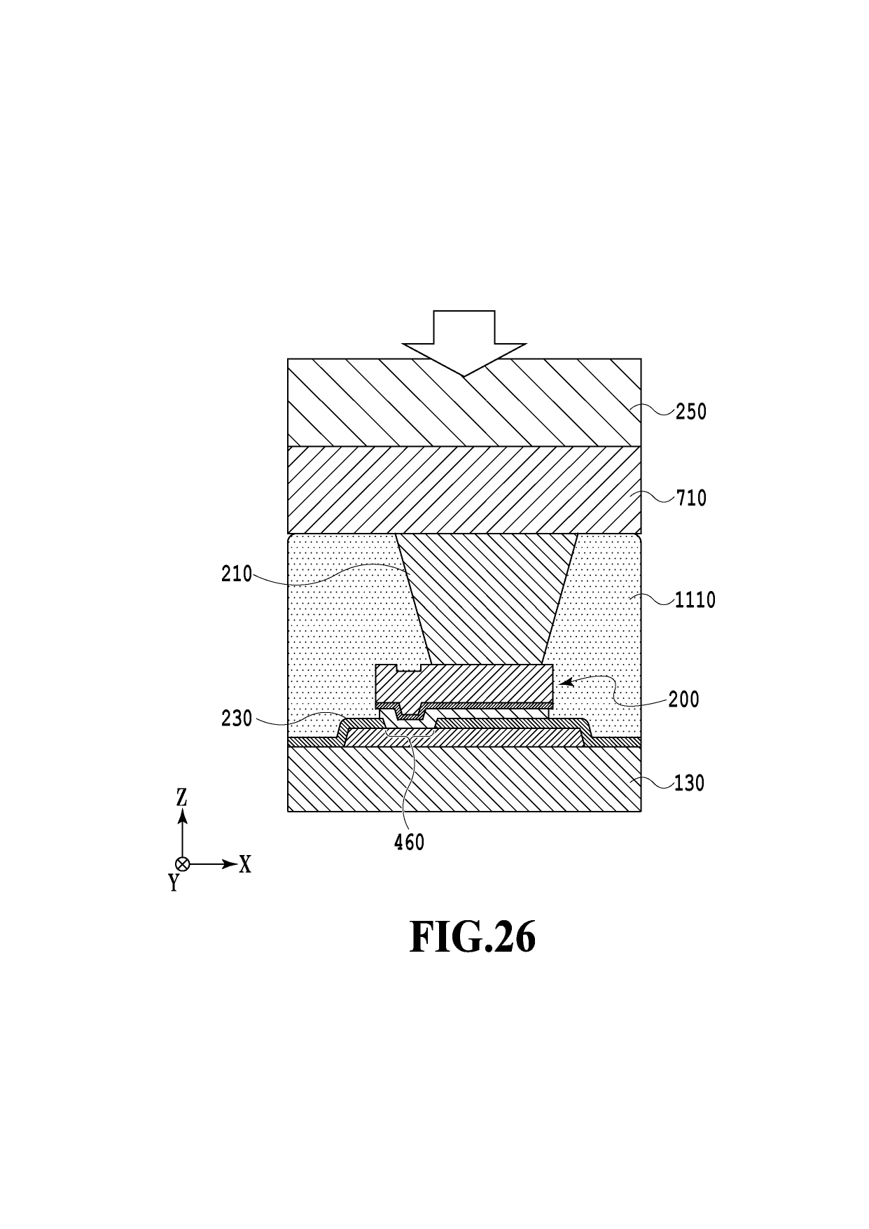

FIG. 26 is a cross-sectional view of FIG. 24. As illustrated in FIG. 26, the region of the through-hole 460 and the region of the electrode terminal 200 pressurized by the wiring 210 are in different positions in the X axis direction and do not overlap each other. That is, in the present embodiment, the opening of the protection film 230 and the pressurization region (contact region) between the electrode terminal and the wiring has a positional relationship of not overlapping each other while viewing from the direction perpendicular to the element substrate 130 (Z axis direction). That is, the opening of the protection film 230 on the element substrate 130 is positioned on the circuit wiring and is arranged in a region other than the region in which the electrode terminal 200 and the wiring 210 overlap each other. Therefore, the stress does not concentrate on the through-hole 460 during the pressurization. Accordingly, it is possible to reduce the possibility that the protection film 230 below the electrode terminal 200 is damaged.

In the present embodiment, the electrode terminal 200 on the chip (element substrate) 130 and the wiring 210 of the flexible substrate 140 have a magnitude relationship in the respective widths. For example, as illustrated in FIGS. 16, 22, and the like, the width of the wiring 210 may be formed thin. Alternatively, the widths may have an opposite relationship.

### Effect of Present Embodiment

As described above, in the present embodiment, the region provided with the through-hole 460 on the electrode terminal 200 and the region of the electrode terminal 200 pressurized by the wiring 210 are in different positions in the X axis direction. Thus, an abutting range between the wiring 210 and the electrode terminal 200 on the chip (element substrate) 130 is provided in a position not overlapping the region provided with the through-hole 460. Accordingly, since the through-hole 460 is not affected by the load of the tool 250, it is possible to avoid the effect on the protection film 230 due to the concentration of the load and the like, and it is possible to suppress the damage of the protection film 230.

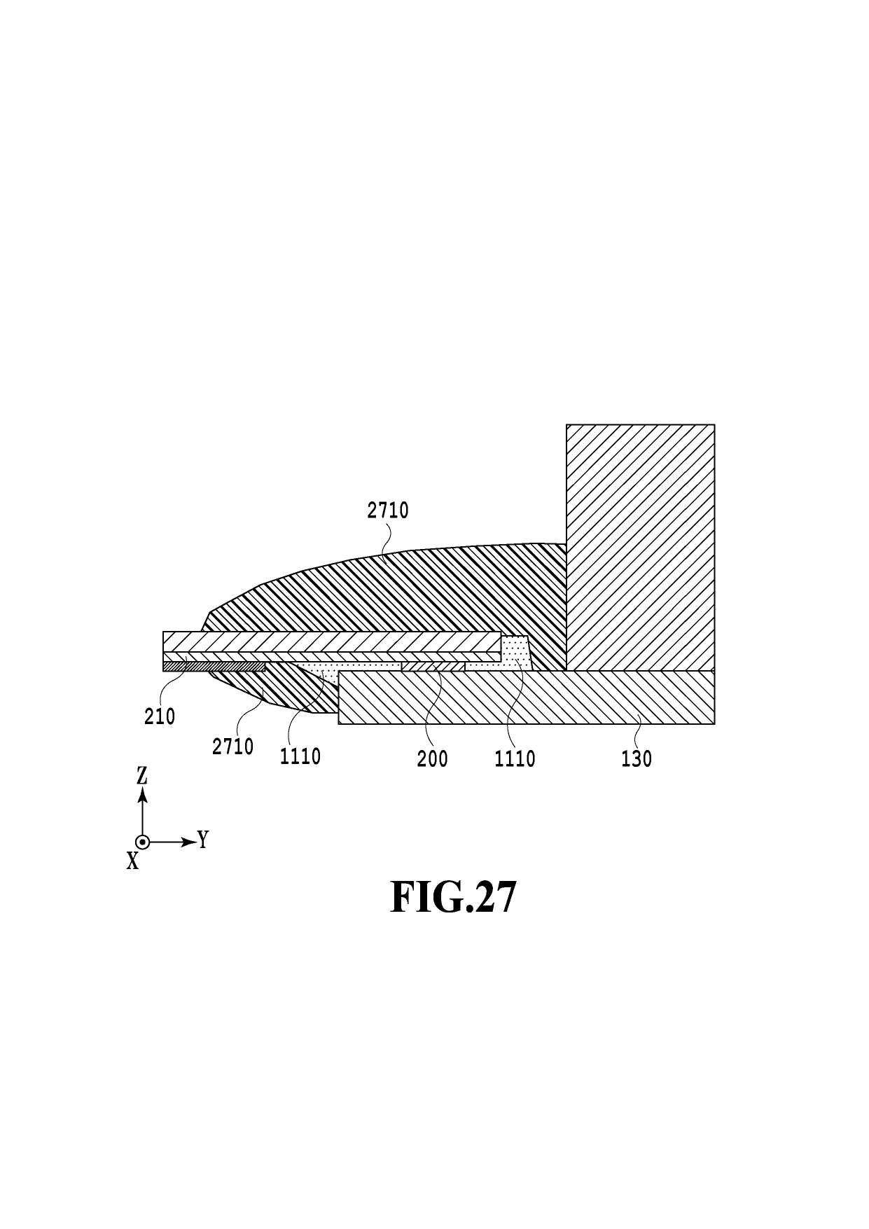

In FIG. 27, a situation after performing sealing of the bonding portion is performed by sealing resin 2710 after the bonding step using the NCP in the above-described first to third embodiments of the present disclosure is illustrated. In each embodiment of the present disclosure, the bonded portion is surrounded by the sealing resin 2710, and thus it is possible to avoid a trouble that occurs due to water and the like from the outside.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, in a configuration in which the electrode terminal on the element substrate and the wiring of the substrate extending from the external circuit are electrically connected to each other by using the thermosetting resin material such as the non-conductive resin, it is possible to suppress the damage of the protection film in the vicinity of the through-hole below the electrode terminal due to the effect of the load on an adhesion region between the electrode and the wiring (for example, the effect of the load caused by the pressure-bonding tool).

This application claims the benefit of Japanese Patent Application No. 2025-073568, filed Apr. 25, 2025, and Japanese Patent Application No. 2026-025552, filed Feb. 19, 2026, which are hereby incorporated by reference herein in their entireties.

What is claimed is:

1. A liquid ejection head, comprising:
an element substrate including an energy element configured to eject a liquid from an ejection port, circuit wiring configured to transmit a signal to the energy element, a protection film including a region covering the circuit wiring and an opening exposing the circuit wiring, and an electrode electrically connected with the circuit wiring via the opening of the protection film; and
a substrate including wiring electrically connected to the electrode, wherein
the element substrate and the substrate are bonded by a resin material, while the element substrate and the substrate are electrically connected to each other with the electrode and the wiring overlapping each other in a facing state, and
the opening of the protection film that is in a position overlapping the electrode is in a position not overlapping a contact region between the electrode and the wiring while viewing from a direction perpendicular to the element substrate.

2. The liquid ejection head according to claim 1, wherein
the contact region is a pressure-bonding region obtained by pressure-bonding, and the opening of the protection film in the position overlapping the electrode is in a position not overlapping the pressure-bonding region between the electrode and the wiring.

3. The liquid ejection head according to claim 1, wherein
the resin material is at least one of non-conductive resin and an anisotropic conductive material.

4. The liquid ejection head according to claim 1, wherein
a bonding portion between the element substrate and the substrate bonded by resin is further covered with sealing resin.

5. The liquid ejection head according to claim 1, wherein
a plurality of the electrodes and a plurality of the wiring are provided, and an interval between the provided electrodes and wiring is a pitch of 100 μm or smaller.

6. The liquid ejection head according to claim 2, wherein
the pressure-bonding region and the opening have a positional relationship of having an interval of 5 μm or greater.

7. The liquid ejection head according to claim 1, wherein
the opening of the protection film in the element substrate is positioned on the circuit wiring and is arranged in a region other than a region in which the electrode and the wiring overlap each other.

8. The liquid ejection head according to claim 1, wherein
the electrode is provided with a metal plating layer on a surface and is formed on the opening of the protection film.

9. The liquid ejection head according to claim 6, wherein
the opening of the protection film has an area that is 30% or less of an area of the electrode.

10. The liquid ejection head according to claim 6, wherein
a region including the opening of the protection film on the electrode is filled with the resin material.

11. The liquid ejection head according to claim 1, wherein
the energy element is a piezoelectric element.

12. A manufacturing method of the liquid ejection head, comprising:
an element substrate including an energy element configured to eject a liquid from an ejection port, circuit wiring configured to transmit a signal to the energy element, a protection film including a region covering the circuit wiring and an opening exposing the circuit wiring, and an electrode electrically connected with the circuit wiring via the opening of the protection film; and
a substrate including wiring electrically connected to the electrode, wherein
the element substrate and the substrate are bonded by a resin material, while the element substrate and the substrate are electrically connected to each other with the electrode and the wiring overlapping each other in a facing state, and
the opening of the protection film that is in a position overlapping the electrode is in a position not overlapping a contact region between the electrode and the wiring while viewing from a direction perpendicular to the element substrate;
the method comprising:
covering the electrode of the element substrate with a resin layer and positioning the wiring of the substrate to introduce to a bonding device; and
bonding the electrode and the wiring via the resin layer.

13. The manufacturing method of the liquid ejection head according to claim 12, wherein
in the bonding, the bonding is pressure-bonding performed by pressurization and heating, the contact region is a pressure-bonding region obtained by pressure-bonding, and the opening of the protection film in the position overlapping the electrode is in the position not overlapping the contact region between the electrode and the wiring while viewing from the direction perpendicular to the element substrate.
